(19) United States
(12) Patent Application Publication
(10) Pub. No.: US 2018/0149896 A1
(43) Pub. Date: May 31, 2018

(54) LIQUID CRYSTAL DISPLAY PANEL

(71) Applicant: SHARP KABUSHIKI KAISHA, Sakai City, Osaka (JP)

(72) Inventors: KAZUYUKI ABURAZAKI, Sakai City (JP); ATSUO KONISHI, Sakai City (JP); TOSHIAKI FUJIHARA, Sakai City (JP)

(21) Appl. No.: 15/575,966

(22) PCT Filed: May 16, 2016
(86) PCT No.: PCT/JP2016/064408

§ 371 Date: Nov. 21, 2017

(30) Foreign Application Priority Data
May 21, 2015 (JP) 2015-103811

(51) Int. Cl. G02F 1/1345; G02F 1/1339; G02F 1/1343; G02F 1/1333

(52) U.S. Cl. CPC G02F 1/1345; G02F 1/1339; G02F 1/134363; G02F 1/13458; G02F 1/1368; G02F 1/13338; G02F 2202/22; G02F 2202/16; G02F 2202/28; G02F 1/13439

(57) ABSTRACT

The present invention provides a liquid crystal display panel that can maintain electrical connection between a transparent conductive film on one of the substrates of the liquid crystal display panel and a terminal on the other substrate and thereby stably eliminate static electricity. The liquid crystal display panel of the present invention includes: a first substrate on which a transparent conductive film is formed; a second substrate on which a terminal whose surface is conductive is formed; a liquid crystal layer held between the first substrate and the second substrate; and a conductive member that electrically connects the transparent conductive film and the terminal, the conductive member containing flaky conductive filler particles and a conductive material different from the flaky conductive filler particles.

### TECHNICAL FIELD

The present invention relates to liquid crystal display panels. The present invention more specifically relates to a liquid crystal display panel having a specific structure suited to liquid crystal display devices in a transverse electric field mode such as an in-plane switching (IPS) mode or a fringe field switching (FFS) mode.

### BACKGROUND ART

Liquid crystal display panels have a structure in which a liquid crystal layer used as a display medium is sandwiched between paired glass substrates, for example. Having a thin profile, light weight, and low power consumption, liquid crystal display panels are now indispensable to products in daily life and business, such as automotive navigation systems, electronic book readers, digital photo frames, industrial equipment, televisions, personal computers, smartphones, and tablet PCs. For these applications, liquid crystal display panels in various modes have been developed which employ various electrode arrangements and substrate designs to vary the optical characteristics of liquid crystal layers.

Known modes to generate electric fields in a liquid crystal layer of a liquid crystal display panel are vertical electric field modes and transverse electric field modes. In a vertical electric field mode liquid crystal display panel, electric fields pointing in a substantially vertical direction (normal direction of the substrate surfaces) are generated in the liquid crystal layer by pixel electrodes formed on one of the substrates (substrate provided with thin-film transistors (TFTs) configured to supply display signals to the pixel electrodes; TFT substrate) and a common electrode formed on the other substrate (counter substrate). Known examples of such a vertical electric field mode liquid crystal display panel include those in a twisted nematic (TN) mode or a vertical alignment (VA) mode which utilizes vertical alignment films and liquid crystal having negative anisotropy of dielectric constant.

In a transverse electric field mode liquid crystal display panel, a common electrode is formed on the TFT substrate together with pixel electrodes such that electric fields pointing in a substantially transverse direction (direction parallel to the substrate surfaces) are generated in the liquid crystal layer by the pixel electrodes and the common electrode. Examples of the transverse electric field mode liquid crystal panel include those in an in-plane switching (IPS) mode or a fringe field switching (FFS) mode in which liquid crystal molecules having positive or negative anisotropy of dielectric constant are aligned parallel to the substrate surfaces and transverse electric fields are generated in the liquid crystal layer.

Conventional transverse electric field mode liquid crystal display devices include, for example, a configuration disclosed in Patent Literature 1 in which the shield electrodes formed on the surface of a counter substrate (CF substrate) in a transverse electric field mode are made of indium zinc oxide (IZO) and the members connecting with the corresponding TFT substrate terminals are made of a conductive paste. Patent Literatures 2 to 4 also each disclose a transverse electric field mode liquid crystal display device including similar connecting members.

### CITATION LIST

### Patent Literature

Patent Literature 1: WO 2013/183505
Patent Literature 2: JP 2010-169791 A
Patent Literature 3: JP 2012-247542 A
Patent Literature 4: JP H09-105918 A

### SUMMARY OF INVENTION

### Technical Problem

Liquid crystal display devices in a transverse electric field mode such as an IPS mode or an FFS mode typically include no electrodes on the liquid crystal layer side surface (back surface) of the color filter substrate (CF substrate) to activate liquid crystal. A surface (front surface) of the CF substrate opposite to the liquid crystal layer, when charged, therefore generates electric fields pointing in the vertical direction (normal direction of the substrate surfaces) to affect the electric fields pointing in the transverse direction (direction parallel to the substrate surfaces) generated in the liquid crystal layer. As a result, the liquid crystal molecules may be aligned in an unfavorable direction to cause display unevenness or any other problem deteriorating the display quality may arise. A known measure to overcome such a disadvantage is a configuration that eliminates static electricity using a transparent conductive film formed on the front surface of the CF substrate via a terminal such as a static eliminating terminal of the TFT substrate on which TFTs are formed. The transparent conductive film and the terminal may be electrically connected to each other by a conductive paste, for example. Here, some types of conductive pastes may cause high electrical resistance in environmental tests (also referred to as reliability tests; especially a high-temperature, high-humidity test) or eventually cause electrical disconnection depending on the surface conditions of the connecting portion (surface conditions of the portion to which the conductive paste is applied).

Typically used conductive pastes are those obtained by mixing mainly flaky conductive filler particles or spherical conductive filler particles into a resin such as epoxy resin or thermoplastic resin. The surface conditions of the portion to which such a conductive paste is applied have been found to vary the peelability of the conductive paste from the surface. For example, a transparent conductive film or a terminal surface made of indium tin oxide (ITO) has fine protrusions and recesses thereon and thus exhibits a high anchoring effect which is less likely to allow the conductive paste to peel, providing relatively stable conductivity. A surface made of IZO, however, is smoother than that made of ITO and thus exhibits a low anchoring effect, allowing the conductive paste to peel easily. A surface made of IZO therefore may cause problems such as an increase in the electrical resistance in environmental tests (especially a high-temperature, high-humidity test) or electrical disconnection (for example, in FIG. 14, a transparent conductive film 23 made of ITO has fine protrusions and recesses on the surface and thus exhibits a high anchoring effect in the region surrounded by a broken line, being less likely to allow a conductive paste 40 to peel, whereas a static eliminating terminal 13 made of IZO has a smooth surface and thus exhibits a low anchoring effect in the region surrounded by a dash-dot line, being more likely to allow the conductive paste 40 to peel).

The invention disclosed in Patent Literature 1 has a configuration in which the shield electrodes on the surface of the counter substrate (CF substrate) in a transverse electric field mode are made of IZO and the members connecting with the corresponding TFT substrate terminals are made of a conductive paste (silver paste) (FIG. 1 in Patent Literature 1). Patent Literature 1, however, fails to suggest a problem of the tendency of separation between the conductive film (especially IZO film) and the conductive paste in environmental tests and measures to deal with the problem. Patent Literatures 2 to 4 also fail to suggest the problem described above and measures to deal with the problem. These inventions can therefore still be improved.

The present invention has been made in view of the current state of the art described above, and aims to provide a liquid crystal display panel that can maintain electrical connection between a transparent conductive film on one of the substrates of the liquid crystal display panel and a terminal on the other substrate and thereby stably eliminate static electricity.

### Solution to Problem

The inventors have made various studies on how to stably eliminate static electricity in a liquid crystal display panel in which a transparent conductive film on one of the substrates and a terminal on the other substrate are electrically connected to each other for static elimination. As a result, they have focused on the material of the conductive adhesive (conductive paste). The inventors have then arrived at using as the conductive paste a material obtained by mixing flaky conductive filler particles and a conductive material different from the flaky conductive filler particles (for example, a conductive material different in shape, material, or size from the flaky conductive filler particles, such as spherical conductive filler particles). Then, connection with a transparent electrode film formed of ITO on the surface of a CF substrate was tested using a conductive paste obtained by mixing flaky conductive filler particles alone into a binder, a conductive paste obtained by mixing a conductive material different from the flaky conductive filler particles alone into a binder, and a conductive paste obtained by mixing the flaky conductive filler particles and the conductive material different from the flaky conductive filler particles into a binder. The results thereof showed that with any of these conductive pastes, the electrical resistance between the conductive paste and ITO was stably low in a high-temperature, high-humidity test, and there was no noticeable problem in the high-temperature, high-humidity test. Meanwhile, in the case of connecting an IZO film formed on the outer surface of a terminal, which has a low anchoring effect, to a conductive paste obtained by mixing the flaky conductive filler particles alone into a binder or a conductive paste obtained by mixing the conductive material different from the flaky conductive filler particles alone into a binder, the electrical resistance between IZO and the conductive paste was high in the high-temperature, high-humidity test. In contrast, with a conductive paste obtained by mixing the flaky conductive filler particles and the conductive material different from the flaky conductive filler particles into a binder, a relatively low, stable electrical resistance was maintained and the environment resistance was excellent. This is how the inventors have conceived of a solution to the above problems and accomplished the present invention. Here, since a problem of electrical resistance increase or electrical disconnection may arise also in the case of connecting a material giving a low surface smoothness (e.g., ITO) and a conductive paste, the concept of the present invention is considered to be effective also in the case where the transparent electrode film on the CF substrate or the outer surface of a terminal on the TFT substrate is formed of a material giving a low surface smoothness, such as ITO. The inventors have also found that, in automatic application of a conductive paste containing flaky conductive filler particles alone to a panel surface using a device including a syringe filled with the conductive paste, the conductive paste, having a high thixotropic index, may not be smoothly ejected from the syringe, deteriorating the workability. Here, a conductive past containing the flaky conductive filler particles as well as a conductive material different from the flaky conductive filler particles has been found to give an appropriate levelling property and thereby achieve good workability (fluidity of the conductive paste itself).

One aspect of the present invention may be a liquid crystal display panel including: a first substrate on which a transparent conductive film is formed; a second substrate on which a terminal whose surface is conductive is formed; a liquid crystal layer held between the first substrate and the second substrate; and a conductive member that electrically connects the transparent conductive film and the terminal, the conductive member containing flaky conductive filler particles and a conductive material different from the flaky conductive filler particles.

The present invention is described in detail below.

In the liquid crystal panel of the present invention, the conductive material different from the flaky conductive filler particles is preferably spherical conductive filler particles.

The second substrate is preferably a TFT substrate. The first substrate is preferably a counter substrate that faces the TFT substrate.

In the liquid crystal display panel of the present invention, at least one of the transparent conductive film of the first substrate and the terminal of the second substrate has a surface roughness Ra of preferably 3 nm or lower, more preferably 2 nm or lower, still more preferably 1 nm or lower.

The surface roughness Ra can be measured by a method in conformity with JIS B 0601:2001.

In the liquid crystal display panel of the present invention, at least one of the transparent conductive film of the first substrate and the surface of the terminal of the second substrate is preferably formed of indium zinc oxide.

In the liquid, crystal display panel of the present invention, the conductive material different from the flaky conductive filler particles preferably has a size that is ½ or smaller than the size of the flaky conductive filler particles.

In the liquid crystal display panel of the present invention, a content ratio by volume between the flaky conductive filler particles and the conductive material different from the flaky conductive filler particles is preferably 10/90 to 90/10.

In the liquid crystal display panel of the present invention, the transparent conductive film of the first substrate is preferably a sensor electrode for a touchscreen.

In the liquid crystal display panel of the present invention, the conductive member is preferably a sealant that bonds the first substrate and the second substrate together to seal the liquid crystal layer between the substrates.

In a preferred mode of the liquid crystal display panel of the present invention, the transparent conductive film is disposed on a surface of the first substrate opposite to the liquid crystal layer.

In another preferred mode of the liquid crystal display panel of the present invention, the transparent conductive film is disposed on a liquid crystal layer side surface of the first substrate.

The liquid crystal display panel of the present invention is preferably in a transverse electric field mode, wherein the second substrate includes: thin-film transistors; pixel electrodes connected to the respective thin-film transistors; and a common electrode, and the liquid crystal display panel utilizes electric fields that are generated between the pixel electrodes and the common electrode and point in a direction parallel to the surfaces of the second substrate, to control an alignment direction of liquid crystal molecules.

In other words, the crystal display panel of the present invention is preferably in a transverse electric field mode, wherein the second substrate includes: thin-film transistors; pixel electrodes connected to the respective thin-film transistors; and a common electrode, and the liquid crystal display panel creates potential differences between the pixel electrodes and the common electrode when utilizing electric fields pointing in a direction parallel to the surface of the second substrate to control an alignment direction of liquid crystal molecules and display an image.

The electric fields pointing in a parallel direction may be any electric fields considered as transverse electric fields in techniques for transverse electric field mode liquid crystal panels, encompassing electric fields pointing in a substantially parallel direction.

In the liquid crystal display panel of the present invention, preferably, the pixel electrodes and the common electrode are disposed in different layers with an insulating film in between, and the surface of the terminal is formed of the same material as the material of the pixel electrodes or the common electrode, whichever is closer to the liquid crystal layer.

### Advantageous Effects of Invention

The liquid crystal display panel of the present invention can maintain electrical connection between a transparent conductive film on one of the substrates of the liquid crystal display panel and static eliminating terminals on the other substrate and thereby stably eliminate static electricity.

### BRIEF DESCRIPTION OF DRAWINGS

FIG. 1 is a schematic cross-sectional view of a liquid crystal display panel of Embodiment 1.

FIG. 2 is a partially enlarged view of FIG. 1, showing the states before and after a high-temperature, high-humidity test.

FIG. 3 is a graph showing the resistance (Ω) of the liquid crystal display panel of Embodiment 1 plotted against time (h) in the high-temperature, high-humidity test.

FIG. 4 is a schematic cross-sectional view of a liquid crystal display panel of Comparative Example 1 before a high-temperature, high-humidity test.

FIG. 5 is a schematic cross-sectional view of the liquid crystal display panel of Comparative Example 1 after the high-temperature, high-humidity test.

FIG. 6 is a graph showing the resistance (Ω) of the liquid crystal display panel of Comparative Example 1 plotted against time (h) in the high-temperature, high-humidity test.

FIG. 7 is a schematic cross-sectional view of a liquid crystal display panel of Comparative Example 2 before a high-temperature, high-humidity test.

FIG. 8 is a schematic cross-sectional view of she liquid crystal display panel of Comparative Example 2 after the high-temperature, high-humidity test.

FIG. 9 is a graph showing the resistance (Ω) of the liquid crystal display panel of Comparative Example 2 plotted against time (h) in the high-temperature, high-humidity test.

FIG. 10 is a schematic cross-sectional view of a liquid crystal display panel of Embodiment 2.

FIG. 11 shows partially enlarged views (two parts) of FIG. 10.

FIG. 12 is a schematic cross-sectional view of a liquid crystal display panel of Embodiment 3.

FIG. 13 is a partially enlarged view of FIG. 12.

FIG. 14 is a schematic cross-sectional view of a liquid crystal display panel that includes a transparent conductive film on a CF substrate and eliminates static electricity using a static eliminating terminal on a TFT substrate.

### DESCRIPTION OF EMBODIMENTS

The present invention is described in more detail below based on embodiments. The embodiments, however, are not intended to limit the scope of the present invention.

The conductive paste (also referred to as a conductive adhesive) as used herein encompasses a conductive paste cured after establishment of electrical connection between a transparent conductive film on one of the substrates of the liquid crystal display panel and a static eliminating terminal on the other substrate.

The flaky conductive filler particles as used herein refer to those having an aspect ratio in the range of 2 to 200. The conductive member “containing flaky conductive filler particles and a conductive material different from the flaky conductive filler particles” means that the conductive member contains conductive filler particles having an aspect ratio in the range of 2 to 200 and a conductive material different in at least one of the material, size, and shape from the conductive filler particles.

The flaky conductive filler particles preferably have an aspect ratio of 3 or higher. The aspect ratio is preferably 150 or lower, more preferably 100 or lower, still more preferably 50 or lower.

The conductive material different from the flaky conductive filler particles may be any conductive material that is different in at least one of the material, size, and shape from the flaky conductive filler particles, and is preferably a conductive material different in size and/or shape from the flaky conductive filler particles.

The conductive material is considered to be “different in size and/or shape from the flaky conductive filler particles” when in a distribution diagram of size indexes (e.g., average volume) or shape indexes (e.g., aspect ratio), two peaks, namely a peak attributed to the flaky conductive filler particles and a peak different from the flaky conductive filler particle peak, are observed.

For example, the conductive material different from the flaky conductive filler particles preferably has a size that is ½ or smaller than the size of the flaky conductive filler particles and/or is spherical conductive filler particles. Here, the size means the average volume per particle of the conductive material or filler.

The spherical conductive filler particles refer to those having an aspect ratio of 1 or higher but lower than 2. The aspect ratio here is more preferably 1.5 or lower.

The aspect ratio of conductive filler particles is obtained by dividing the longer diameter (length of the longest portion) by the shorter diameter (length of the shortest portion) of the particles. The longer diameter and the shorter diameter can be determined by measuring the longer diameters and the shorter diameters of 100 or more filler particles with an electron microscope.

The conductive member is considered to contain spherical conductive filler particles and flaky conductive filler particles when a peak is observed in two ranges, which are the range of 1 to lower than 2 and the range of 2 to 200, in an aspect ratio distribution diagram. In the aspect ratio distribution diagram, peaks are preferably observed only in the respective two ranges of 1 to lower than 2 and 2 to 200.

In each of the following embodiments, the transparent conductive film on the CF substrate is disposed on the entire front or back surface of the CF substrate of the liquid crystal display panel, and this structure is preferred in order to sufficiently eliminate static electricity of the CF substrate. Yet, the transparent conductive film can be disposed on part (e.g., part corresponding to the display region) of the front or back surface of the CF substrate.

Although the static eliminating terminal on the TFT substrate is disposed on the back surface (viewing side main surface) of the TFT substrate of the liquid crystal display panel in each of the following embodiments, the static eliminating terminal may be disposed at any position as long as it is grounded and can eliminate static electricity. For example, the static eliminating terminal may be disposed on the front surface (backlight side main surface) of the TFT substrate or on a side surface of the TFT substrate.

### Embodiment 1

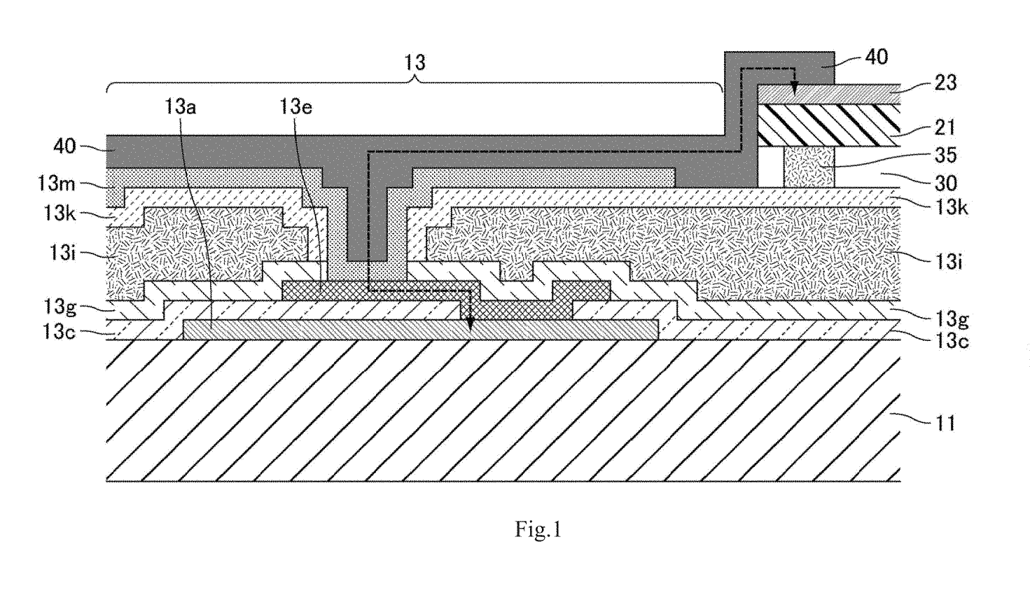

FIG. 1 is a schematic cross-sectional view of a liquid crystal display panel of Embodiment 1. A liquid crystal display panel shown in FIG. 1 is a transverse electric field mode liquid crystal display panel whose CF substrate 21 includes no electrodes to activate liquid crystal.

A transparent conductive film 23 (e.g., ITO film) formed on the surface of the CF substrate 21 and a static eliminating terminal 13 on a TFT substrate 11 are connected by a conductive paste 40. The static eliminating terminal 13 has a configuration in which a gate metal 13a, a gate insulating film 13c, a source metal 13e, a first inorganic insulating film 13g, an organic insulating film 13i, a second inorganic insulating film 13k, and a transparent conductive film 13m (e.g., IZO film) having high surface smoothness are stacked in the given order. The transparent conductive film 13m (e.g., IZO film) having high surface smoothness constitutes the surface of the static eliminating terminal 13 to be connected to the conductive paste 40. Here, the gate metal 13a is formed of a conductive line material such as copper (Cu), molybdenum (Mo), aluminum (Al), titanium (Ti), titanium nitride (TiN), an alloy of these metals, or a laminate of these metals, and is formed in the same layer as the gate electrodes of TFTs on the TFT substrate 11. The source metal 13e is formed of a conductive line material such as Cu, Mo, Al, Ti, TiN, an alloy of these metals, or a laminate of these metals, and is formed in the same layer as the source and drain electrodes of the TFTs. The organic insulating film 13i is an insulating layer formed in the same layer as the organic insulating layer disposed between the TFTs and a common electrode. The second inorganic insulating film 13k is an insulating layer formed in the same layer as an insulating film disposed between the common electrode and the pixel electrodes.

The transparent conductive film 13m having high surface smoothness is a transparent conductive film that is formed of an electrode material such as IZO and is formed in the same layer as the pixel electrodes. Here, some transverse electric field mode liquid crystal panels include pixel electrodes each having fine (for example, about 2 to 4 μm) slits at a narrow pitch (for example, about 2 to 4 μm). Such pixel electrodes each having slits and the transparent conductive film 13m having high surface smoothness in the static eliminating terminal 13 can be obtained in the same step by forming an IZO film by sputtering and then patterning the resulting film by known photolithography and wet etching. The pixel electrodes of a transverse electric field mode liquid crystal panel can be formed of an opaque metal (e.g., Mo, Ti), but can be more advantageous in the case of being a transparent conductive film such as an IZO film because a higher transmittance of the liquid crystal panel can be achieved.

In this manner, the static eliminating terminal 13 is formed in the same layer as the TFTs or pixel electrodes by the same processes, so that no additional step of forming the static eliminating terminal 13 is required.

Although the pixel electrodes, the second inorganic insulating film 13k, and the common electrode are formed in the given order from the liquid crystal layer side in Embodiment 1, the places of the pixel electrodes and the common electrode can be switched. In such a case, fine slits are formed in the common electrode, and the transparent conductive film 13m having high surface smoothness is formed of an electrode material and is formed in the same layer as the common electrode.

In FIG. 1, the conduction path is taken through the transparent conductive film 23, the conductive paste 40, the transparent conductive film 13m having high surface smoothness, the source metal 13e, and the gate metal 13a in the given order. The gate metal 13a is grounded, for example, via a flexible printed circuit (FPC) connected to an end of the TFT substrate 11.

In the structure of the liquid crystal display panel of Embodiment 1, ITO and IZO may be switched. That is, the transparent conductive film 23 may be formed of IZO and have high surface smoothness, while the transparent conductive film 13m may be formed of ITO and have low surface smoothness. This structure can similarly achieve the effects of the present invention. Also, the transparent conductive film 23 and the transparent conductive film 13m may both be formed of IZO, which makes the effects of the present invention more significant. Furthermore, the transparent conductive film 23 and the transparent conductive film 13m may both be formed of ITO.

The “high surface smoothness” means that the surface roughness Ra is 3 nm or lower, more preferably 2 nm or lower, still more preferably 1 nm or lower. Thereby, the effects of the present invention can be significantly achieved.

The surface roughness Ra refers to an arithmetic mean roughness measured in conformity with JIS B 0601:2001.

The gate insulating film 13c, the first inorganic insulating film 13g, and the second inorganic insulating film 13k are preferably formed of silicon nitride (SiNₓ), for example. The organic insulating film 13l is preferably formed of an acrylic photosensitive resin, for example.

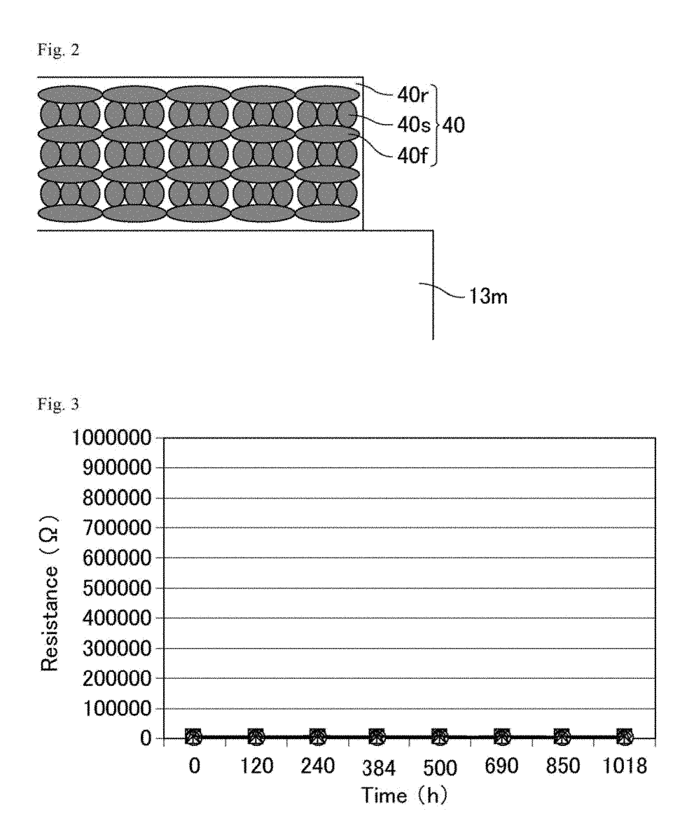

FIG. 2 is a partially enlarged view of FIG. 1, showing the states before and after a high-temperature, high-humidity test. FIG. 2 shows part of each of the transparent conductive film 13m having high surface smoothness and the conductive paste 40 shown in FIG. 1.

The conductive paste 40 contains flaky conductive filler particles 40f, a conductive material different from the flaky conductive filler particles, such as spherical conductive filler particles 40s, and a binder 40r (resin). In Embodiment 1, the surface of the static eliminating terminal 13 is a conductive film (e.g., IZO film) having high surface smoothness, which is a preferred structure. Yet, the surface may be formed of any other conductive material.

The conductive paste 40 applied to the conductive film herein is a material obtained by mixing the flaky conductive filler particles 40f and a conductive material different from the flaky conductive filler particles, such as the spherical conductive filler particles 40s, into the binder 40r. The liquid crystal panel of the present invention can therefore exhibit high environment resistance and maintain stable electrical resistance. Here, the effect of maintaining the electrical resistance can be significantly improved in the case where the conductive film is one having high surface smoothness, such as an IZO film.

The conductive paste is obtained by mixing flaky conductive filler particles and a conductive material different from the flaky conductive filler particles, such as spherical conductive filler particles, into a binder. In particular, the conductive paste is preferably obtained by mixing flaky conductive filler particles and spherical conductive filler particles into a binder. Examples of the conductive paste include those containing flaky conductive filler particles having a large surface area and spherical conductive filler particles having a small surface area.

The conductive material different from flaky conductive filler particles preferably has a size that is ½ or smaller, more preferably ⅓ or smaller, than that of the flaky conductive filler particles.

Here, the “size” refers to the average volume per particle of a conductive material or filler.

In such a case, the conductive material different from the flaky conductive filler particles, such as the spherical conductive filler particles 40s, can favorably fill the spaces between the flaky conductive filler particles 40f, so that the flaky conductive filler particles 40f and the conductive material different from the flaky conductive filler particles, such as the spherical conductive filler particles 40s, are less movable even when the binder 40r (resin) deforms in an environmental test. Hence, the electrical connection is maintained between the flaky conductive filler particles 40f and the conductive material different from the flaky conductive filler particles, such as the spherical conductive filler particles 40s, in the conductive paste. Also, the conductive paste 40 is prevented from peeling off of the conductive film 13m having high surface smoothness, especially a conductive film formed of a material giving high surface smoothness (e.g., IZO), whereby the electrical connection is maintained between the conductive paste 40 and the conductive film 13m having high surface smoothness.

Examples of the material of the conductive filler particles include silver, gold, iron, and carbon. Preferred examples of the material of the flaky conductive filler particles 40f include silver and gold. Preferred examples of the conductive material different from the flaky conductive filler particles, such as the spherical conductive filler particles 40s, include carbon.

The content ratio by volume between the flaky conductive filler particles and the conductive material different from the flaky conductive filler particles is preferably 10/90 to 90/10, more preferably 20/80 to 80/20, still more preferably 30/70 to 70/30, particularly preferably 40/60 to 60/40.

The binder used in the conductive paste may be any of various known resins. Preferred examples thereof include epoxy resin, phenolic resin, and silicone resin.

The liquid crystal panel of Embodiment 1 has a basic structure in which the TFT substrate 11, a liquid crystal layer 30 containing liquid crystal molecules having positive anisotropy of dielectric constant, or negative anisotropy or dielectric constant, and the CF substrate 21 are stacked in the given order. The TFT substrate 11 and the CF substrate 21 are bonded together by a sealant 35. On the outer surface side of each of the TFT substrate 11 and the CF substrate 21 is provided a polarizing plate. An alignment film may be provided on the liquid crystal layer side of each of the TFT substrate 11 and CF substrate 21. The polarizing plates and alignment films are not illustrated in FIG. 1. The CF substrate is called such because it includes color filters (CFs), but the CF substrate may lack CFs and the TFT substrate may include CFs as long as the CF substrate is a counter substrate of the TFT substrate.

FIG. 3 is a graph showing the resistance (Ω) of the liquid crystal display panel of Embodiment 1 plotted against time (h) in the high-temperature, high-humidity test.

The transverse electric field mode liquid crystal display panel illustrated in FIG. 1 was subjected to a high-temperature, high-humidity [conditions: 60° C., 95% RH (relative humidity)] environmental test, and the electrical resistance between the transparent conductive film 23 (made of ITO) and the gate metal 13a illustrated in FIG. 1 (portion indicated by the double-sided arrow) was measured.

FIG. 3 shows a graph obtained in the case of using a conductive paste obtained by mixing flaky conductive filler particles (flaky silver particles) and spherical conductive particles (carbon particles) into a binder. Unlike in Comparative Example 1 and Comparative Example 2 described below, no increase in the electrical resistance was observed after time passed (an electrical resistance of 5 kΩ or lower was maintained throughout the high-temperature, high-humidity test). With such an electrical resistance of 2 MΩ or lower, favorable contact performance (electrical connection performance) can be achieved.

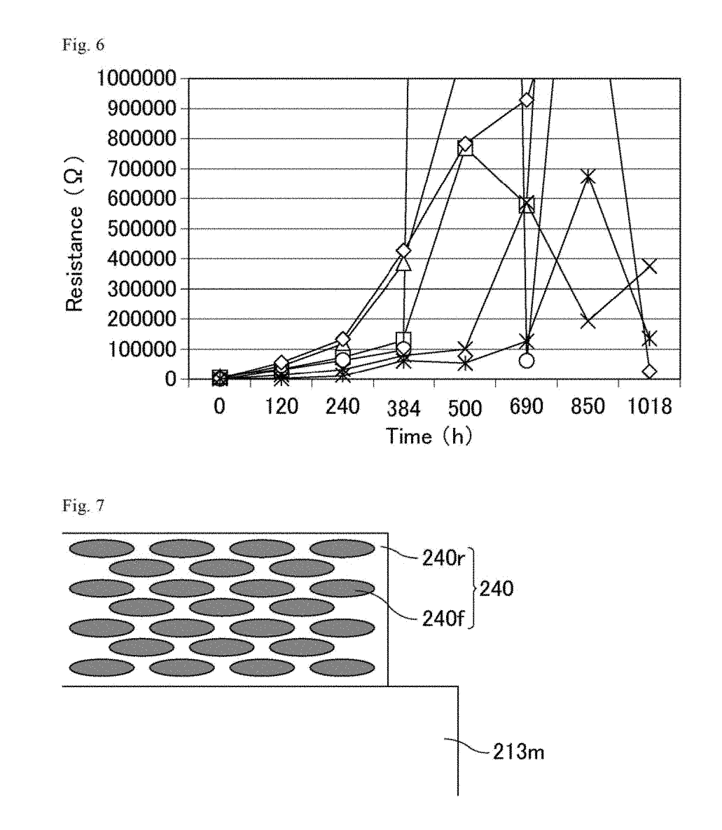

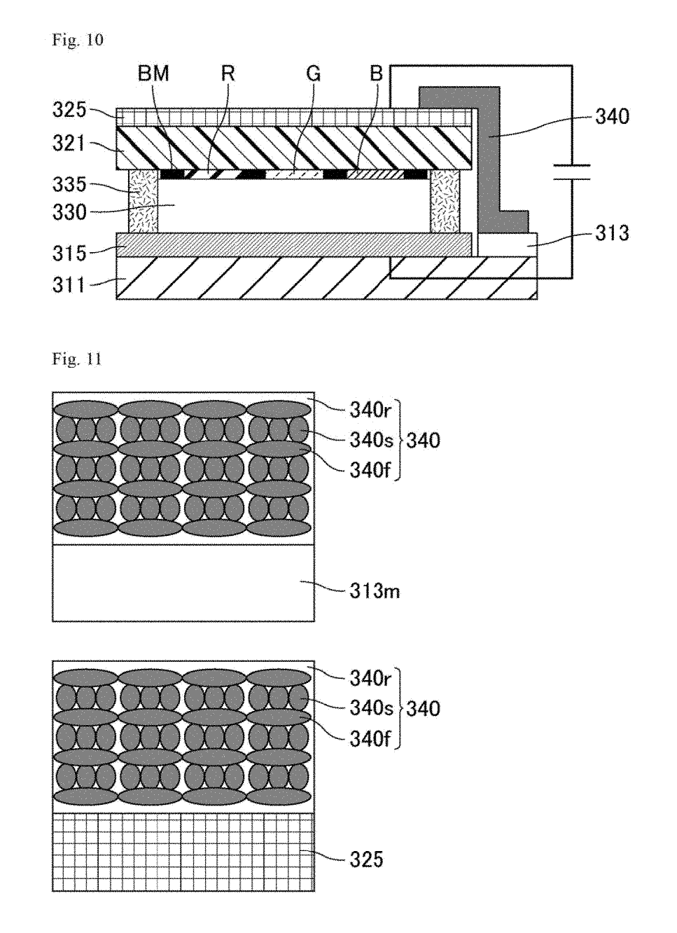

Here, the environmental test was conducted several times under the same high-temperature, high-humidity conditions, and FIG. 3 shows the results of these tests. The same applies to FIG. 6 (Comparative Example 1) and FIG. 9 (Comparative Example 2) below.

### COMPARATIVE EXAMPLE 1

A liquid crystal display panel of Comparative Example 1 is similar to the liquid crystal display panel of Embodiment 1, except that the conductive paste used was obtained by mixing spherical conductive filler particles (spherical silver particles) alone as the conductive filler particles into the binder.

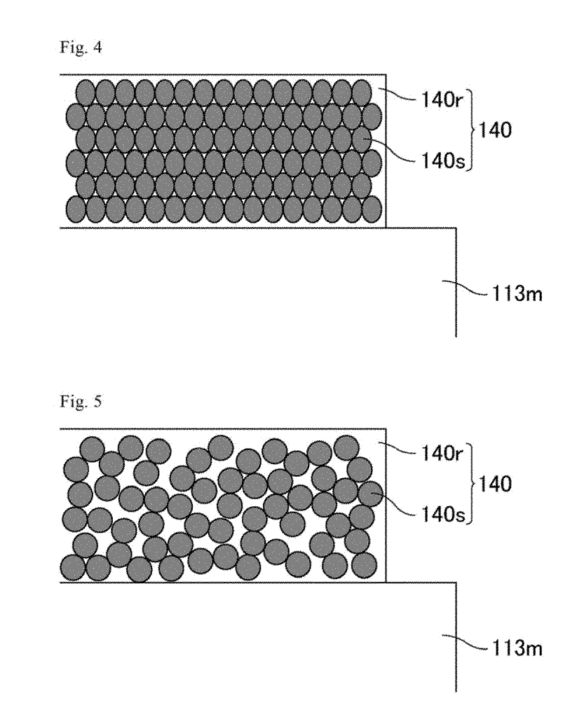

FIG. 4 is a schematic cross-sectional view of a liquid crystal display panel of Comparative Example 1 before a high-temperature, high-humidity test. FIG. 5 is a schematic cross-sectional view of the liquid crystal display panel of Comparative Example 1 after the high-temperature, high-humidity test. In the liquid crystal display panel of Comparative Example 1, spherical conductive filler particles 140s, which are only in point contact with each other, move as a binder 140r deforms with time as shown in FIG. 4 and FIG. 5. As a result, the point contact between the spherical conductive filler particles 140s is lost in the conductive paste 140, which is presumed to cause electrical disconnection.

FIG. 6 is a graph showing the resistance (Ω) of the liquid crystal display panel of Comparative Example 1 plotted against time (h) in the high-temperature, high-humidity test. The liquid crystal display panel of Comparative Example 1 was subjected to the high-temperature, high-humidity [conditions: 60° C., 95% RH (relative humidity)] environmental test, and the electrical resistance between the transparent conductive film on the CF substrate and the gate metal was measured. FIG. 6 shows that the electrical resistance increases as time passes.

### COMPARATIVE EXAMPLE 2

A liquid crystal display panel of Comparative Example 2 is similar to the liquid crystal display panel of Embodiment 1, except that the conductive paste used was obtained by mixing flaky conductive filler particles (flaky silver particles) alone as the conductive filler into a binder.

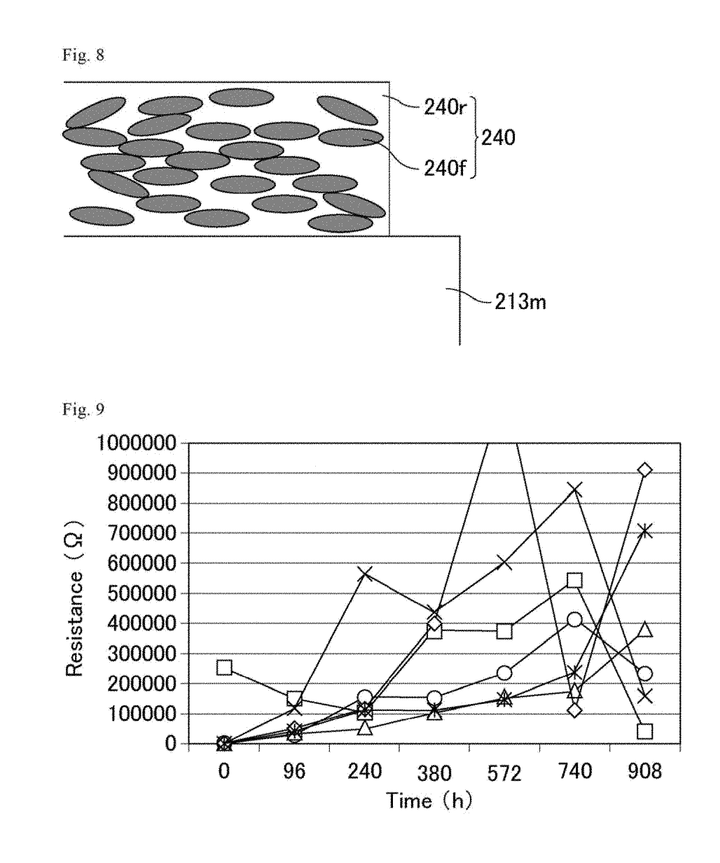

FIG. 7 is a schematic cross-sectional view of a liquid crystal display panel of Comparative Example 2 before a high-temperature, high-humidity test. FIG. 8 is a schematic cross-sectional view of the liquid crystal display panel of Comparative Example 2 after the high-temperature, high-humidity test. In the liquid crystal display panel of Comparative Example 2, flaky conductive filler particles 240f, which are only in surface contact with each other, move as a binder 240r deforms with time. As a result, the surface contact between the flaky conductive filler particles 240f is lost in the conductive paste 240, which is presumed to cause electrical disconnection.

FIG. 9 is a graph showing the resistance (Ω) of the liquid crystal display panel of Comparative Example 2 plotted against time (h) in the high-temperature, high-humidity test. The liquid crystal display panel of Comparative Example 2 was subjected to the high-temperature, high-humidity [conditions: 60° C., 95% RH (relative humidity)] environmental test, and the electrical resistance between the transparent conductive film on the CF substrate and the gate metal was measured. FIG. 9 shows that the electrical resistance increases as time passes.

### Embodiment 2

FIG. 10 is a schematic cross-sectional view of a liquid crystal display panel of Embodiment 2. FIG. 10 shows an embodiment of a transverse electric field mode liquid crystal display panel with an in-cell touchscreen in which one of the electrodes for a touchscreen are disposed on the CF substrate.

The liquid crystal display panel of Embodiment 2 has a configuration in which a TFT substrate 311, a TFT substrate-side sensor electrode 315, a liquid crystal layer 330, a layer including red color filters R, green color filters C, blue color filters B, and a black mask BM, a CF substrate 321, and a CF substrate-side sensor electrode 325 (transparent conductive film) are stacked in the given order. That is, the CF substrate-side sensor electrode 325 is formed on a surface (front surface) of the CF substrate 321 opposite to the liquid crystal layer. On the TFT substrate 311 is formed a static eliminating terminal 313 that is electrically connected to the CF substrate-side sensor electrode 325 by a conductive paste 340. In between the paired substrates is disposed a sealant 335. The TFT substrate-side sensor electrode 315 can be, for example, a common electrode used to align (activate) liquid crystal molecules. The CF substrate-side sensor electrode 325 is for a touchscreen, and the static eliminating terminal 313 is connected to a circuit configured to detect a touch position between the TFT substrate-side sensor electrode 315 and the CF substrate-side sensor electrode 325, via FPC connected to an end of the TFT substrate 311, for example. A touch position is detected using capacitance between the TFT substrate-side sensor electrode 315 and the CF substrate-side sensor electrode 325.

Although Embodiment 2 employs a configuration in which one of the sensor electrodes is formed on the TFT substrate 311, the sensor electrode may be formed on the liquid crystal layer side surface (back surface) of the CF substrate 321. In this case, a touch position is detected using capacitance between the sensor electrodes formed on the respective front and back surfaces of the CF substrate.

FIG. 11 shows partially enlarged views (two parts) of FIG. 10. In Embodiment 2, favorable electrical connection is achieved using the conductive paste 340 that is similar to the conductive paste of Embodiment 1 and obtained by mixing flaky conductive filler particles 340f and a conductive material different from the flaky conductive filler particles, such as spherical conductive filler particles 340s, into a binder 340r. The electrical connection can be significantly improved especially in the case where a transparent conductive film having high surface smoothness, such as an IZO film, constitutes a conductive film 313m on the surface of the static eliminating terminal and/or the CF substrate-side sensor electrode 325.

The liquid crystal display panel of Embodiment 2 can achieve a stable electrical resistance of 5 kΩ or lower and favorable contact performance as in the case illustrated in FIG. 3.

The other configurations of the liquid crystal display panel of Embodiment 2 are similar to those of the liquid crystal display panel of Embodiment 1 described above.

### Embodiment 3

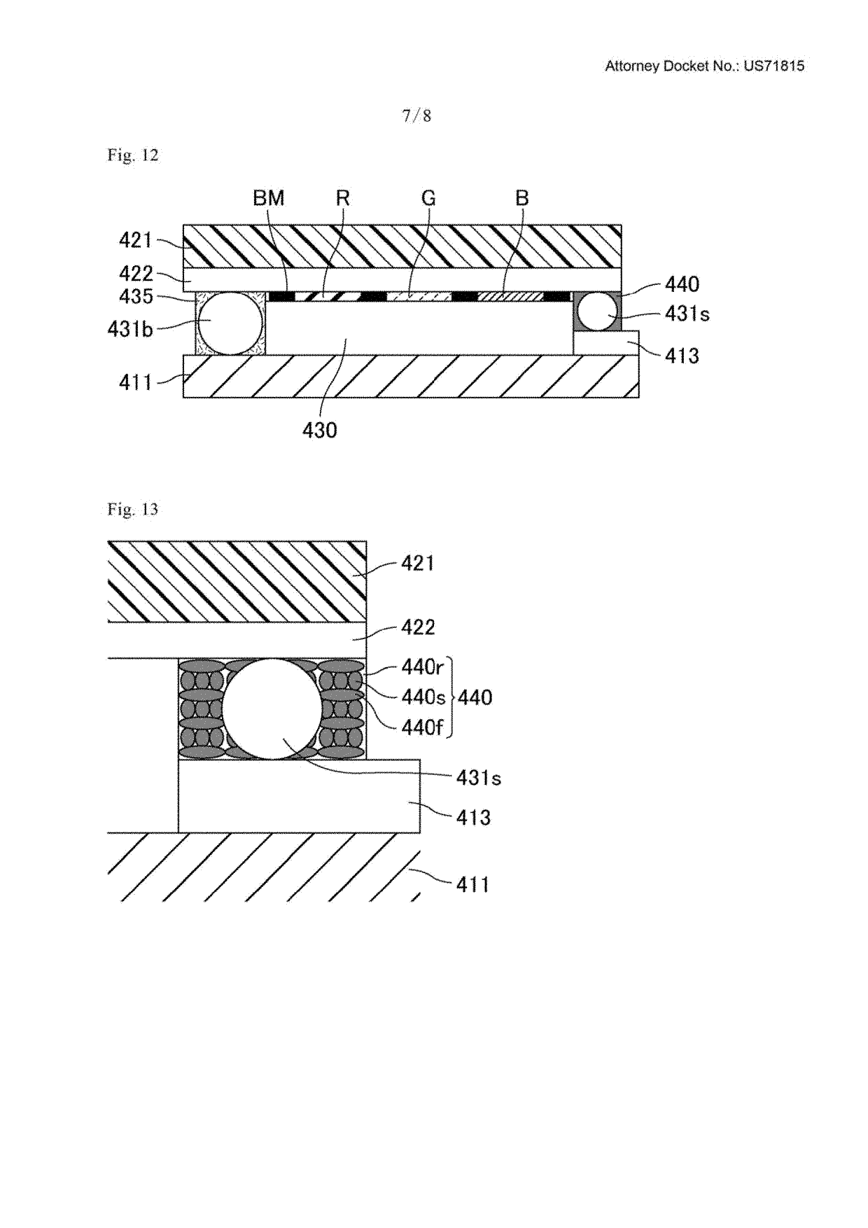

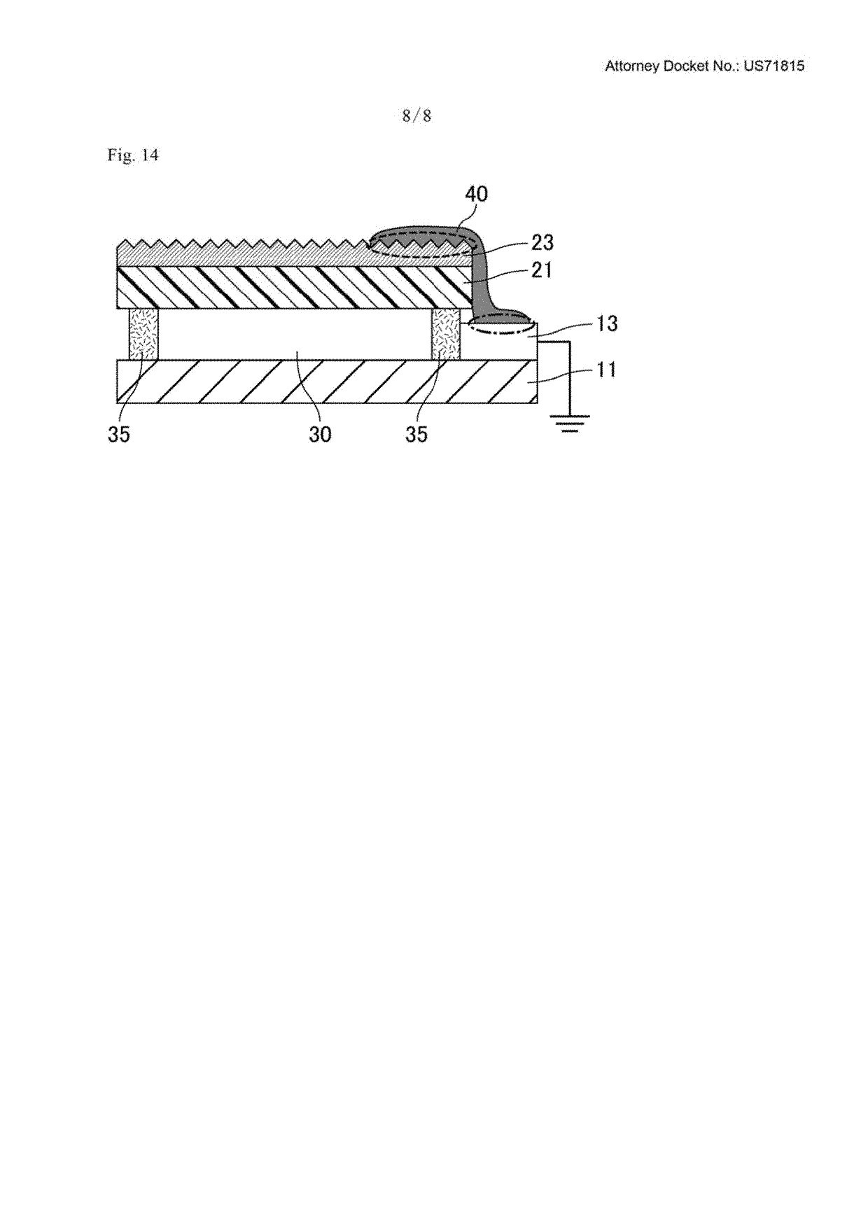

FIG. 12 is a schematic cross-sectional view of a liquid crystal display panel of Embodiment 3. FIG. 12 shows an embodiment in which a transparent conductive film 422 (e.g., ITO or IZO film) is provided on the back surface of a CF substrate 421 in an IPS mode or FFS mode liquid crystal display panel, and a conductive paste 440 is used as a constituent of the sealant, so that the transparent conductive layer 422 on the CF substrate and a static eliminating terminal 413 are electrically connected. Although Embodiment 1 and Embodiment 2 each employed a configuration eliminating static electricity using a transparent conductive film formed on the front surface of the CF substrate, Embodiment 3 employs a configuration eliminating static electricity using a transparent conductive film 422 formed on the back surface (liquid crystal layer side surface) of the CF substrate. Since the transparent conductive film 422 is not an electrode connected to TFTs to activate liquid crystal, the transparent conductive film 422 and the static eliminating terminal 413 are electrically connected by the conductive paste 440 to prevent electrification. In this configuration, the paired substrates are bonded together and conductive filler particles (e.g., silver particles, gold particles, or carbon particles) are partially mixed into a sealant that seals a liquid crystal layer 430 between the substrates such that the transparent conductive film 422 on the CF substrate 421 and the static eliminating terminal 413 on a TFT substrate 411 are electrically connected. In Embodiment 3, the member (conductive paste 440) that electrically connects the transparent conductive film 422 and the static eliminating terminal 413 is similar to the conductive paste in Embodiment 1 and is obtained by mixing flaky conductive filler particles 440f and a conductive material different from the flaky conductive filler particles, such as spherical conductive filler particles 440s, into a binder 440r. In between the paired substrates are disposed spacers 431b and 431s.

The liquid crystal display panel of Embodiment 3 has a configuration in which the TFT substrate 411, the liquid crystal layer 430, a color layer including red color filters R, green color filters C, blue color filters B, and a black mask BM, the transparent conductive film 422, and the CF substrate 421 are stacked in the given order. On the TFT substrate 411 is formed the static eliminating terminal 413 that is electrically connected to the transparent conductive film 422 by the conductive paste 440. The conductive paste 440 functions also as a sealant. In regions where no static eliminating terminal 413 is disposed, a non-conductive sealant 435 is disposed.

FIG. 13 is a partially enlarged view of FIG. 12. The liquid crystal display panel of Embodiment 3 can also achieve the effects of the present invention using the conductive paste in the present invention. The effects of the present invention can be significant especially in the case where a material giving high surface smoothness, such as IZO, constitutes the transparent conductive film 422 on the CF substrate 421 or the surface of the static eliminating terminal 413 (transparent conductive film).

The liquid crystal display panel of Embodiment 3 can achieve a stable electrical resistance of 5 kΩ or lower and favorable contact performance as in the case shown in FIG. 3.

The other configurations of the liquid crystal display panel of Embodiment 3 are similar to those of the liquid crystal display panel of Embodiment 1.

Embodiment 3 is also applicable to the configuration shown in Embodiment 2 in which an in-cell touchscreen sensor electrode is formed on the liquid crystal layer side surface (back surface) of the CF substrate. In this case, the transparent conductive film 422 corresponds to the sensor electrode and is electrically connected to the static eliminating terminal 313 by the conductive paste 440. The static eliminating terminal 313 is connected to a circuit configured to detect a touch position via FPC connected to an end of the TFT substrate 411, for example.

Although Embodiment 3 shows an example in which the sealant contains the conductive paste 440, the conductive paste 440 may be disposed separately from the sealant. In this case, the binder of the conductive paste may be a material different from the sealant.

The liquid crystal display panel of the present invention is suitable for on-board devices (e.g., automotive navigation systems), electronic book readers, digital photo frames, industrial equipment, televisions, personal computers, smartphones, and tablet PCs.

The concept of the present invention is suited to transverse electric field mode liquid crystal display panels having a configuration in which electrodes used to control alignment of liquid crystal are provided only to the second substrate, not to the first substrate. Thereby, electrification in the first substrate, which is likely to occur in a liquid crystal display panel in which electrodes to control alignment of liquid crystal are not provided to the first substrate, can be stably eliminated. For example, the concept of the present invention is preferably applied to an IPS mode liquid crystal display panel or an FFS mode liquid crystal display panel. In the liquid crystal display panel of the present invention, for example, the second substrate is preferably provided with: thin-film transistors; pixel electrodes connected to the respective thin-film transistors; and a common electrode, and the liquid crystal display panel preferably utilizes electric fields that are generated between the pixel electrodes and the common electrode and point in a direction parallel to the surfaces of the second substrate, to control an alignment direction of liquid crystal molecules.

Also, in the liquid crystal display panel of the present invention, the surface of the static eliminating terminal is preferably formed of the same material as the material of the pixel electrodes or the common electrode, whichever is closer to the liquid crystal layer.

### REFERENCE SIGNS LIST

11, 311, 411: TFT substrate
13, 313, 413: Static eliminating terminal
13a: Gate metal
13c: Gate insulating film
13e: Source metal
13g: First inorganic insulating film
13i: Organic insulating film
13k: Second inorganic insulating film
13m, 113m, 213m, 313m: Transparent conductive film having high surface smoothness
21, 321, 421: CF substrate
23, 422: Transparent conductive film
30, 330, 430: Liquid crystal layer
35, 335, 435: Sealant
40, 140, 240, 340, 440: Conductive paste
40f, 240f, 340f, 440f: Flaky conductive filler particles
40r, 140r, 240r, 340r: Binder
40s, 140s, 340s, 440s: Spherical conductive filler particles
315: TFT substrate-side sensor electrode
325: OF substrate-side sensor electrode
431h, 431s: Spacer
R: Red color filter
G: Green color filter
B: Blue color filter
BM: Black mask

1. A liquid crystal display panel comprising:
a first substrate on which a transparent conductive film is formed;
a second substrate on which a terminal whose surface is conductive is formed;
a liquid crystal layer held between the first substrate and the second substrate; and
a conductive member that electrically connects the transparent conductive film and the terminal,
the conductive member containing flaky conductive filler particles and a conductive material different from the flaky conductive filler particles.

2. The liquid crystal display panel according to claim 1,
wherein the conductive material different from the flaky conductive filler particles is spherical conductive filler particles.

3. The liquid crystal display panel according to claim 1,
wherein at least one of the transparent conductive film of the first substrate and the terminal of the second substrate has a surface roughness Ra of 3 nm or lower.

4. The liquid crystal display panel according to claim 1,
wherein at least one of the transparent conductive film of the first substrate and the surface of the terminal of the second substrate is formed of indium zinc oxide.

5. The liquid crystal display panel according to claim 1,
wherein the conductive material different from the flaky conductive filler particles has a size that is ½ or smaller than the size of the flaky conductive filler particles.

6. The liquid crystal display panel according to claim 1,
wherein a content ratio by volume between the flaky conductive filler particles and the conductive material different from the flaky conductive filler particles is 10/90 to 90/10.

7. The liquid crystal display panel according to claim 1,
wherein the transparent conductive film of the first substrate is a sensor electrode for a touchscreen.

8. The liquid crystal display panel according to claim 1,
wherein the conductive member is a sealant that bonds the first substrate and the second substrate together to seal the liquid crystal layer between the substrates.

9. The liquid crystal display panel according to claim 1,
wherein the transparent conductive film is disposed on a surface of the first substrate opposite to the liquid crystal layer.

10. The liquid crystal display panel according to claim 1,
wherein the transparent conductive film is disposed on a liquid crystal layer side surface of the first substrate.

11. The liquid crystal display panel according to claim 1, which is in a transverse electric field mode,
wherein the second substrate comprises:
thin-film transistors;
pixel electrodes connected to the respective thin-film transistors; and
a common electrode, and
the liquid crystal display panel utilizes electric fields that are generated between the pixel electrodes and the common electrode and point in a direction parallel to the surfaces of the second substrate, to control an alignment direction of liquid crystal molecules.

12. The liquid crystal display panel according to claim 11,
wherein the pixel electrodes and the common electrode are disposed in different layers with an insulating film in between, and
the surface of the terminal is formed of the same material as the material of the pixel electrodes or the common electrode, whichever is closer to the liquid crystal layer.
